(19) United States
(12) Patent Application Publication
(10) Pub. No.: US 2022/0203636 A1
(43) Pub. Date: Jun. 30, 2022

(54) MICROFABRICATION OF OPTICAL COMPONENTS AND COMB DRIVE ACTUATORS FOR LIDAR APPLICATIONS

(71) Applicant: BEIJING VOYAGER TECHNOLOGY CO., LTD., Beijing (CN)

(72) Inventors: Yue Lu, Mountain View, CA (US); Youmin Wang, Berkeley, CA (US)

(73) Assignee: BEIJING VOYAGER TECHNOLOGY CO., LTD., Beijing (CN)

(21) Appl. No.: 17/138,404

(22) Filed: Dec. 30, 2020

Related U.S. Application Data
(63) Continuation-in-part of application No. 17/134,432, filed on Dec. 27, 2020.
Application No. 17/134,432 is a continuation-in-part of application No. 17/136,938, filed on Dec. 29, 2020.
Application No. 17/136,938 is a continuation of application No. 17/135,959, filed on Dec. 28, 2020.

(51) Int. Cl. B29D 11/00; G02B 26/10; G02B 26/08

(52) U.S. Cl. CPC B29D 11/0048; G02B 26/108; G01S 7/4817; B29K 2883/00; G02B 26/0875

(57) ABSTRACT

Embodiments of the disclosure provide a method for fabricating a shaped optical component, and a method for making a micro assembly with a plurality of shaped optical components. The method for fabricating a shaped optical component includes creating a master mold containing a substrate with a predefined surface contour. The method further includes generating a polydimethylsiloxane (PDMS) mold with a concave part having an inverse pattern matching the predefined surface contour. The method additionally includes filling the concave part of the PDMS mold with a light-curable optical adhesive. The method additionally includes sealing the adhesive-filled concave part with a flat PDMS slab to form a PDMS structure. The method additionally includes curing and hardening the optical adhesive inside the PDMS structure to form the shaped optical component. The method additionally includes detaching the shaped optical component from the PDMS structure.

### CROSS-REFERENCE TO RELATED APPLICATIONS

This application is a continuation-in-part of U.S. application Ser. No. 17/134,432, filed on Dec. 27, 2020, entitled “MEMS ACTUATED VIBRATORY RISLEY PRISM FOR LIDAR,” and is a continuation-in-part of U.S. application Ser. No. 17/136,938, filed on Dec. 29, 2020, entitled “DYNAMIC OUTGOING BEAM DIVERGENCE TUNING IN LIDAR,” which is a continuation of U.S. application Ser. No. 17/135,959, filed on Dec. 28, 2020, entitled “MEMS ACTUATED ALVAREZ LENS FOR TUNABLE BEAM SPOT SIZE IN LIDAR.” The entire contents of each of the above-identified applications are incorporated herein by reference.

### TECHNICAL FIELD

The disclosure relates to manufacturing a light detection and ranging (LiDAR) system, and more particularly to, a method for microfabrication of optical components and comb drive actuators for LiDAR applications.

### BACKGROUND

In existing LiDAR systems, many optical components are static. That is, once configured, these optical components generally provide the LiDAR systems with fixed optical properties, such as fixed field-of-view, fixed outgoing beam divergence, fixed returning beam spot sizes, etc. However, in environment sensing, optical components may need tuning to account for changes in environment information. For instance, if a LiDAR system is applied for navigation, such as to aid autonomous driving navigation, the LiDAR system may experience dynamic environmental changes, such as from a scene with crowd surrounding objects (e.g., building, city facilities, vehicles, pedestrians, etc.) to a scene with rarely any surrounding objects. These dynamic environment changes may require a LiDAR system to tune certain optical properties of the system to achieve optimized detections.

Tuning of optical properties can be realized by actuating the respective optical components. The actuators and the optical components are typically fabricated separately, and therefore may require alignment and assembling when integrated into the LiDAR system.

Embodiments of the disclosure address the above problems by providing methods for microfabrication of optical components and the corresponding comb drive actuators for dynamically manipulating these optical components, so as to tune certain optical properties of a LiDAR system in a dynamic environment.

### SUMMARY

Embodiments of the disclosure provide a method for fabricating a shaped optical component using a replication molding process. The method includes creating a master mold containing a substrate with a predefined surface contour. The method further includes generating a polydimethylsiloxane (PDMS) mold with a concave part having an inverse pattern matching the predefined surface contour. The method additionally includes filling the concave part of the PDMS mold with a light-curable optical adhesive. The method additionally includes sealing the optical adhesive-filled concave part with a flat PDMS slab to form a PDMS structure. The method additionally includes curing and hardening the optical adhesive inside the PDMS structure to form the shaped optical component. The method additionally includes detaching the shaped optical component from the PDMS structure.

Embodiments of the disclosure further provide a method for making a micro assembly with a plurality of movable optical components. The method includes fabricating a plurality of shaped optical components using a replication molding process. The method further includes constructing a comb drive actuator-based platform for each of the plurality of shaped optical components. The method additionally includes integrating each of the plurality of shaped optical components into a respective comb drive actuator-based platform. The method additionally includes aligning a plurality of comb drive actuator-based platforms with integrated shaped optical components to form the micro assembly.

It is to be understood that both the foregoing general description and the following detailed description are exemplary and explanatory only and are not restrictive of the disclosure, as claimed.

### BRIEF DESCRIPTION OF THE DRAWINGS

FIG. 1A illustrates a schematic diagram of an exemplary rotary Risley prism-based scanning mechanism for a LiDAR system, according to embodiments of the disclosure.

FIG. 1B illustrates a schematic diagram of an exemplary pair of movable Alvarez lenses for tuning outgoing beam divergence in a LiDAR system, according to embodiments of the disclosure.

FIG. 2 illustrates a schematic diagram of an exemplary process for fabricating a Risley prism, according to embodiments of the disclosure.

FIG. 3 illustrates a schematic diagram of an exemplary process for fabricating an Alvarez lens, according to embodiments of the disclosure.

FIG. 4A illustrates a schematic diagram of a top view of an exemplary angular comb drive actuator-based platform without showing an integrated Risley prism, according to embodiments of the disclosure.

FIG. 4B illustrates a schematic diagram of a top view of an exemplary angular comb drive actuator-based platform with an integrated Risley prism shown, according to embodiments of the disclosure.

FIG. 5A illustrates a top view of an exemplary Alvarez lens integrated into a comb drive actuator-based platform including two comb drives, according to embodiments of the disclosure.

FIG. 5B illustrates a side view of two exemplary Alvarez lenses integrated into respective comb drive actuator-based platforms, according to embodiments of the disclosure.

FIG. 6 illustrates a schematic diagram of an exemplary process for fabricating a comb drive actuator-based platform main structure, according to embodiments of the disclosure.

FIG. 7 is a flow chart of an exemplary method for making a micro assembly with a plurality of movable optical components, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the disclosure provide an exemplary method for microfabricating a shaped optical component using a replication molding process. The method may start by creating a master mold containing a substrate with a predefined surface contour and generate a polydimethylsiloxane (PDMS) mold with a concave part having an inverse pattern matching the predefined surface contour. The concave part of the PDMS mold is then filled, e.g., with a light-curable optical adhesive. A PDMS structure can be formed by sealing the optical adhesive-filled concave part with a flat PDMS slab. After curing and hardening the optical adhesive inside the PDMS structure, the shaped optical component is formed and can be detached from the PDMS structure. The shaped optical components fabricated through the disclosed method may include various optical components that may be applied to a LiDAR system. For instance, the fabricated optical components may include an Alvarez lens, a pair of which may be applied to collimate beam, e.g., to collimate the outgoing beams emitted towards the environment surrounding a LiDAR system. For another instance, the fabricated optical components may include a Risley prism, two or more of which together may serve as a scanning mechanism for a LiDAR system, and may be controlled to rotate at various speeds and/or rotational directions to generate different scanning patterns in environmental sensing by the LiDAR system.

Embodiments of the disclosure also provide an exemplary method for making various comb drive actuator-based platforms for integrating associated optical components fabricated through the foregoing process. The method may start by preparing a silicon on insulator (SOI) wafer having three different layers, i.e., a bottom silicon substrate layer, a middle buried oxide layer, and a top silicon device layer. A polysilicon layer may be deposited over the top silicon device layer and under the bottom silicon substrate layer, respectively. A photolithography pattern transfer process may be performed and a patterned hard mask layer may be then prepared on the front side silicon device layer. Etching may be then performed following the patterned hard mask to form a comb drive actuator-based platform main structure. Similar etching may be also performed to generate a backside cavity. To release the formed comb drive actuator-based platform main structure from the ROI wafer substrate, an additional etching of the buried oxide layer may be further performed. The released comb drive actuator-based platform main structure may be further furnished with spring structures and stationary anchors to form a complete comb drive actuator-based platform for optical component integration.

According to one embodiment, the exemplary method may make a comb drive actuator-based platform for an Alvarez lens. The fabricated comb drive actuator-based platform for an Alvarez lens may include a couple of comb drives located on two sides of an Alvarez lens holder. The two comb drive actuators may cooperatively control an integrated Alvarez lens to move in one direction. In some embodiments, two similar comb drive actuator-based platforms may be fabricated and each may allow an Alvarez lens to be integrated thereto. The movement of one or both Alvarez lenses, controlled by the comb drive actuator-based platform, may cause a displacement between the two Alvarez lenses. The displacement length between the two Alverez lenses may be controlled to tune a beam divergence passing through the Alvarez lenses.

According to another embodiment, the exemplary method for making various comb drive actuator-based platforms may also be used to make an angular comb drive actuator-based platform for a Risley prism. The fabricated angular comb drive actuator-based platform for a Risley prism may have a plurality of angular comb drive actuators that encircle a Risley prism holder. Each angular comb drive actuator may include a set of curved stationary teeth and a set of curved rotary teeth that can make a radial movement towards the stationary teeth. The radial movements of the rotary teeth of the plurality of angular comb drive actuators may cause an integrated Risley prism to rotate clockwise or anti-clockwise at different speeds. In some embodiments, two or more Risley prisms may be integrated into the respective angular comb drive actuator-based platforms, and the rotations of the two or more Risley prisms at various speeds and rotational directions may allow different scanning patterns to be generated by the rotary Risley prisms.

From the above, it can be seen that the disclosed microfabrication methods may be applied to microfabricate optical components with different shapes, structures, and optical properties, or to microfabricate comb drive actuator-based platforms for integrating each microfabricated optical component. When these microfabricated optical components are integrated into the corresponding comb drive actuator-based platforms (together may be referred to as micro assemblies), so that they form an integrated micro assembly. The comb drive actuator-based platforms may control the integrated optical components to move or rotate. Such movement or rotation of one or more optical components may cause certain optical properties to change dynamically when properly disposed in a LiDAR system. For instance, movements of one or more integrated Risley prisms in a LiDAR system may cause beam divergence of outgoing laser beams to dynamically change when there is an environmental change. For another instance, the rotations of one or both integrated Alvarez lenses in a LiDAR system may cause the scanning pattern of the LiDAR system to dynamically change too when there is an environmental change. Accordingly, the disclosed various microfabrication methods may provide movable optical components that can be actuated in high-speed to fine-tune certain optical properties of a LiDAR system on-the-fly, thereby allowing optimized detections to be achieved by the LiDAR system in a dynamic environment.

The features and advantages described herein are not all-inclusive and many additional features and advantages will be apparent to one of ordinary skill in the art in view of the figures and the following descriptions.

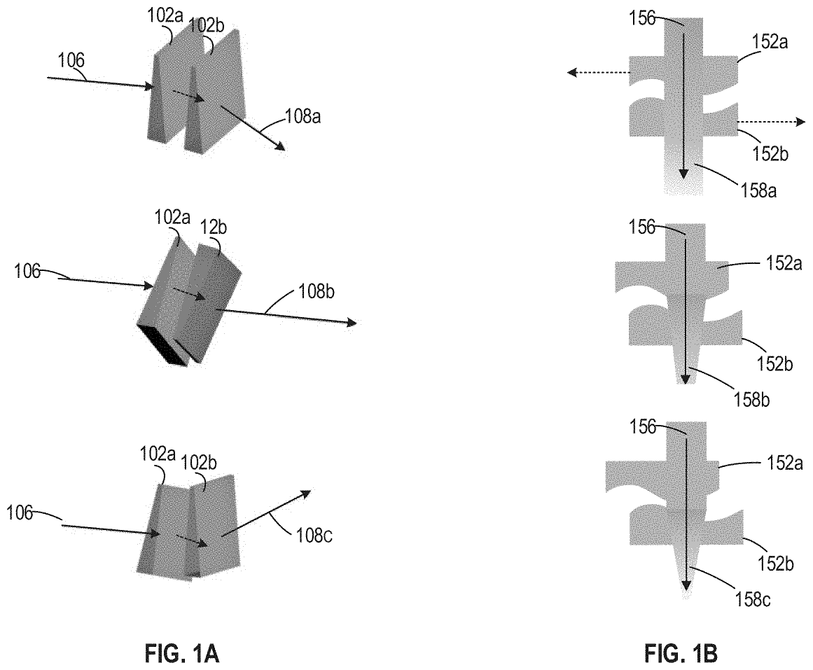

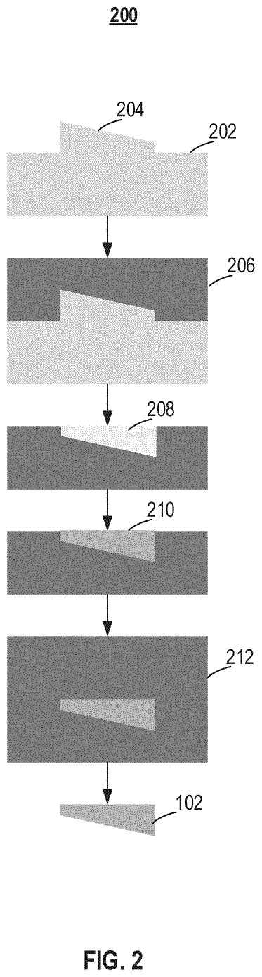

FIG. 1A illustrates a schematic diagram of an exemplary rotary Risley prism-based scanning mechanism for a LiDAR system, according to embodiments of the disclosure. As illustrated, the exemplary rotary Risley prism-based scanning mechanism for the LiDAR system may include two or more (while only two Risley prisms 102a and 102b are illustrated in the figure) Risley prisms (together may be referred to as Risley prism 102) that are aligned along an optical path of a transmitter of the LiDAR system. Each Risley prism 102a or 102b may be fabricated through a replication molding process, as will be described in FIG. 2. As also illustrated in FIG. 1A, each Risley prism 102a or 102b may be rotated to different positions, causing a laser beam 106 passing through the Risley prisms to refract and deviate from the original direction. By rotating the Risley prisms to different positions, the outgoing laser beams may be directed at different directions, as indicated by the outgoing laser beams 108a, 108b, and 108c in the figure. Through precisely controlling the rotating positions of the Risley prisms 102a and 102b at different time points, a scanning pattern may be generated for the LiDAR system. In addition, through controlling the relative rotation speeds and/or rotation directions of the Risley prisms, different scanning patterns may be generated, thereby allowing tuning of scanning patterns generated by the Risley prism-based scanning mechanism in a LiDAR system.

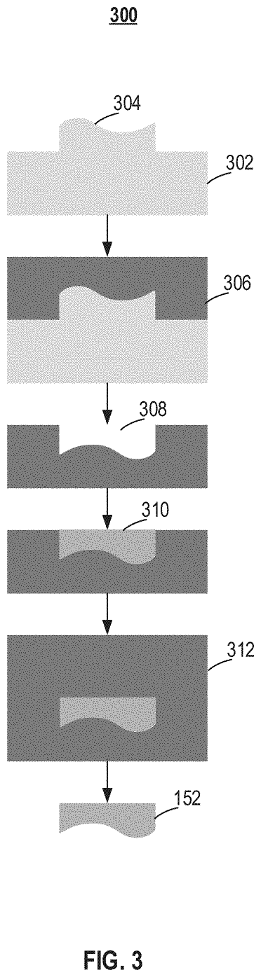

FIG. 1B illustrates a schematic diagram of an exemplary pair of movable Alvarez lenses for tuning outgoing beam divergence in a LiDAR system, according to embodiments of the disclosure. As illustrated, the exemplary movable Alvarez lenses for a LiDAR system may include two Alvarez lenses 152a and 152b (together may be referred to as Alvarez lens 152) arranged in tandem. Each Alvarez lens 152a or 152b may be fabricated through a replication molding process, as will be described in FIG. 3. As also illustrated in FIG. 1B, each Alvarez lens 152a or 152b may be controlled to move laterally (i.e., the horizontal directions as indicated by the dotted arrows in the figure), causing a laser beam 156 passing through the pair of Alvarez lenses to be collimated to a different divergence 158a, 158b, or 158c, as illustrated in the figure. Accordingly, through moving the Alvarez lenses to different displacement lengths between the two Alvarez lenses, the beam divergence of the outgoing laser beams in a LiDAR system may be dynamically adjusted.

As can be seen from the above, Risley prisms 102 and Alvarez lenses 152 may be used to tune certain optical properties of a LiDAR system in environmental sensing. Specific processes for making Risley prism 102 and Alvarez lens 152 are further described in detail hereinafter in FIGS. 2-3.

FIG. 2 illustrates a schematic diagram of an exemplary fabrication process 200 for making a Risley prism, according to embodiments of the disclosure. Consistent with embodiments of the disclosure, a transparent Risley prism may be fabricated through a replication molding process. In some embodiments, first, a single-point diamond turning technique with freeform surface fabrication capability, or a computer numerical control (CNC) milling process, may be used to make a Risley prism surface contour 204 on an Aluminum substrate 202. Such formed mold with both Aluminum substrate 202 and the Risley prism surface contour 204 may be collectively referred to as a master mold. Next, a polydimethylsiloxane (PDMS) mold 206 with a concave part having an inverse pattern may be further fabricated through a replication process. In some embodiments, a liquid PDMS prepolymer may be poured onto the master mold, followed by complete curing of the prepolymer PDMS. The liquid PDMS prepolymer may include a two-part silicone that cures to a flexible silicone elastomer. The two-part silicone may include a base and a curing agent mixed at a certain ratio (e.g., a ratio of 10:1 by weight or by volume). The base and the curing agent may be mixed manually or mixed through an automated process and then dispensed onto the master mold for curing to PDMS mold 206. The curing process for the mixed two-part silicone may be performed under various conditions. For instance, the curing process may be operated under 25° C. for 48 hours, 65° C. for 2 hours, 100° C. for 45 minutes, 125° C. for 20 minutes, 150° C. for 10 minutes, etc. After curing, the formed PMDS mold 206 may be detached from the master mold and used for making Risley prism through another replication process, as described below.

In some embodiments, after being detached from the master mold and overturned, the PMDS mold 206 may contain a concave part 208 that matches the Risley prism surface contour 204. To make a Risley prism, concave part 208 of PDMS mold 206 may be filled with a UV-curable optical adhesive 210. The selection of a UV-curable optical adhesive, instead of heat-curable optical adhesives, may eliminate the heat-induced strain during the curing process. Many different UV-curable optical adhesives may be selected for fabricating a Risley prism. For instance, UV-curable optical adhesive 210 may be NOA83H® (a single component liquid adhesive that cures in seconds to a tough, hard polymer when exposed to ultraviolet light), or may be NOA88® (an optically clear, liquid adhesive that will cure when exposed to long wavelength ultraviolet light), or may be another suitable UV-curable optical adhesive. In some embodiments, a UV-curable optical adhesive may be selected based on a target refraction index of a Risley prism. For instance, a UV-curable optical adhesive that can provide a high refraction index for a Risley prism may be selected if the Risley prism is to be used to increase the field-of-view of a LiDAR system. In some embodiments, UV-curable optical adhesives that can provide different refraction indexes may be selected for fabricating different Risley prisms. For instance, Risley prism-based scanning mechanism in a LiDAR system may include a plurality of Risley prisms that each has a different refraction index, and thus UV-curable optical adhesives that can provide different refraction indexes may be selected for filling concave part 208 of PDMS mold 206.

Once filled with UV-curable optical adhesive 210, concave part 208 of PDMS mold 206 may be sealed by another pre-made PDMS slab 212. The PDMS slab 212 may be made similarly as described above for making the PDMS mold 206, except that a master mold used for making PDMS slab 212 may not have a surface contour 204 but rather have a flat surface, and thus the formed PDMS slab 212 may also have a flat surface. When sealing concave part 208 of PDMS mold 206 filled with UV-curable optical adhesive 210, PDMS slab 212 may be slowly pushed from one side of concaved part 208, to remove the excessive UV-curable optical adhesive while also ensuring no air bubble created during the sealing process. The sealed PDMS structure or assembly may then be subject to UV irradiation for curing UV-curable optical adhesive 210 inside the PDMS structure. Depending on the selected UV-curable optical adhesive, UV with different wavelengths and/or strengths may be applied for UV curing. Further, the time required for the curing process may also vary and depend on the applied UV wavelength and strength. For instance, NOA83H is sensitive to the whole range of UV light from 320 nm to 380 nm with a peak sensitivity at around 365 nm, while NOA88 is sensitive to long wavelength ultraviolet light.

In some embodiments, after curing UV-curable optical adhesive 210, the cured optical adhesive (i.e., the formed Risley prism) may be further hardened, e.g., by placing the whole PDMS structure into a convection oven that is set to a certain temperature or temperature range for a certain period (e.g., 60° C., 30 mins). The cured and hardened Risley prism may be then detached from the PDMS structure. Due to the low surface energy of PDMS, the adhesion between the formed Risley prism and the PDMS structure is extremely small, making the detachment very easy without affecting the surface quality of the formed Risley prism 102.

Referring now to FIG. 3, another exemplary process 300 for fabricating an Alvarez lens is provided, according to embodiments of the disclosure. As can be seen from the figure, process 300 for fabricating an Alvarez lens is very similar to process 200 for fabricating a Risley prism. Briefly, a single-point diamond turning technique with freeform surface fabrication capability or a CNC milling process may be used to make a target surface contour 304 on an Aluminum substrate 302, which may act as a master mold. Here, the target surface contour 304 may be an Alvarez lens surface contour, instead of a Risley prism surface contour shown in FIG. 2. Next, a PDMS mold 306 with a concave part having an inverse pattern may be fabricated using a standard replication process, in which PDMS prepolymer is poured onto the master mold followed by complete curing under a certain temperature or a temperature range for a certain period (e.g., 65° C. for 2 hours). The cured PDMS mold 306 with the concave part 308 may be then detached and overturned with concave part 308 facing up. Concave part 308 of PDMS mold 306 may be then filled with a UV-curable optical adhesive and sealed by another flat PDMS slab 312. After exposure under UV light with a certain wavelength for a certain period (e.g., a few seconds at around 365 nm if NOA83H is used), the whole PDMS structure may be then put into a convection oven for further hardening the formed Alvarez lens. Due to the low surface energy of PDMS, the adhesion between the formed Alvarez lens 152 and the PDMS structure is extremely small, making the detachment very easy without affecting the element surface quality of the formed Alvarez lens 152.

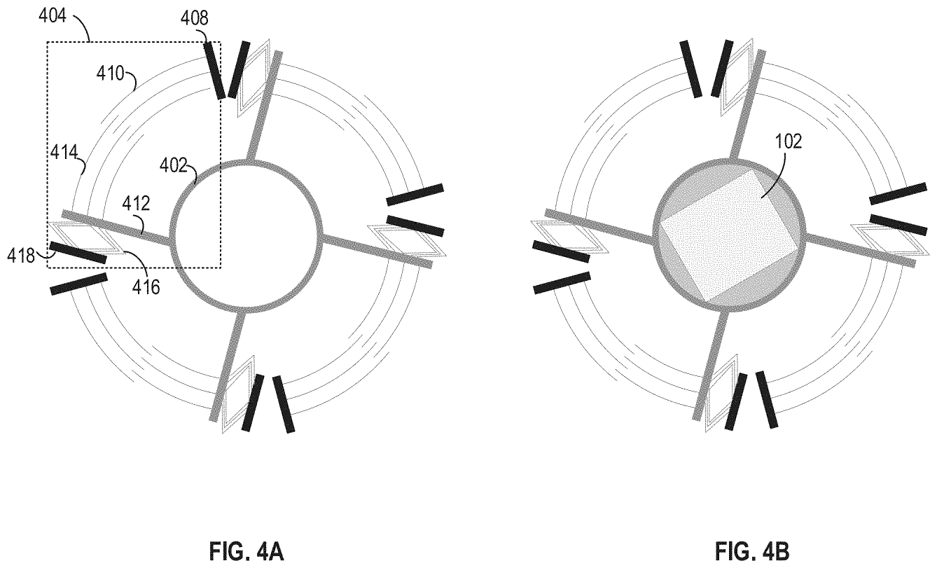

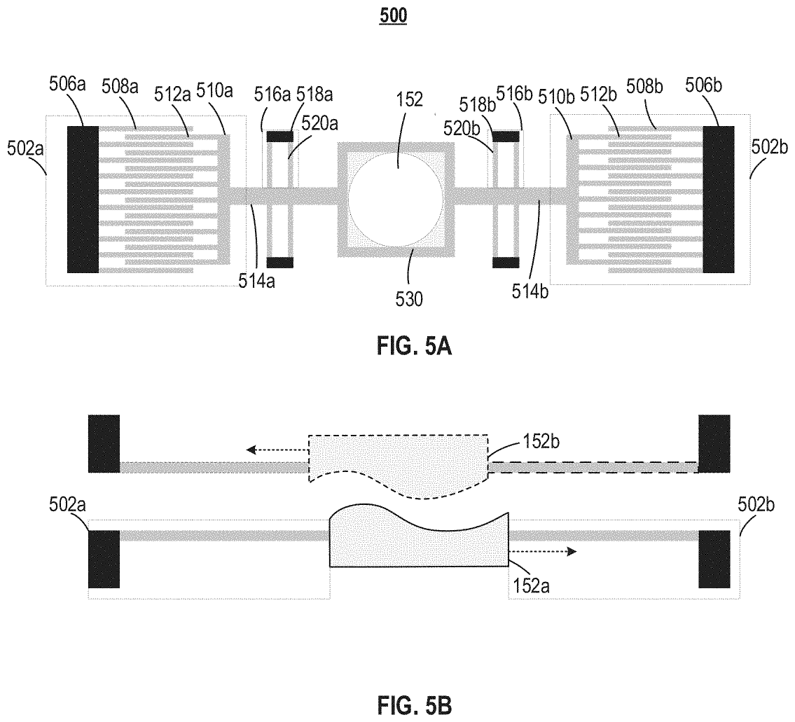

While FIGS. 2-3 each illustrate a process for microfabricating a single Risley prism 102 or an Alvarez lens 152, in some embodiments, multiple Risley prisms 102 or Alvarez lenses 152 may be fabricated through the forgoing process 200 or 300. These multiple Risley prisms and Alvarez lens may have the same or different shapes and may be made using materials with same or different optical properties such as different refraction indexes for Risley prisms. In some embodiments, a master mold with different surface contours 204 may be used to make different shapes of optical components other than those described above. For instance, each fabricated Risley prism 102 may have a shaped cross-section that can be a rectangular, square, trapezoid, triangle, circle, ellipse, or can be other proper shapes depending on the surface contour 204 in the master mold. For another instance, each fabricated Alvarez lens may have a shaped cross-section that can be a rectangular, square, circle, or can be other proper shapes depending on the surface contour 204. In some embodiments, different optical adhesives may be used to make optical components with different optical properties, as previously described. By introducing the diversity into the above-described process 200 or 300, many different optical components with different optical properties may be fabricated through the process 200 or 300, which may be then integrated into certain comb drive actuator-based platforms, to achieve different purposes in optical sensing, as described further in details in FIGS. 4A-5B.

FIGS. 4A-4B each illustrate a schematic diagram of a top view of an exemplary angular comb drive actuator-based platform without or with an integrated Risley prism shown respectively, according to embodiments of the disclosure. As illustrated, a Risley prism (e.g., Risley prism 102 fabricated through process 200) may be integrated into a support platform comprising a plurality of angular comb drive actuators 404 that form a “tire” shape structure, where the Risley prism may be located at the center while the plurality of angular comb drive actuators 404 may encircle the center. As illustrated, an angular comb drive actuator-based platform may include a ring-shaped mounting structure 402 that is rotatable when driven by the plurality of angular comb drive actuators 404. Ring-shaped mounting structure 402 may serve as a Risley prism holder to allow a Risley prism to be fixedly mounted around an inner edge or surface of the ring-shaped mounting structure 402 at different locations or edges. The controlled rotation of ring-shaped mounting structure 402 may thus cause the attached Risley prism to rotate at a certain speed and direction.

As illustrated in FIG. 4A, each angular comb drive actuator 404 may include a stationary comb and a rotary comb. A stationary comb may include a stationary anchor 408 and a set of stationary teeth 410 fixed to the corresponding stationary anchor. Each stationary tooth may be an arc-shaped tooth. A rotary comb may include a rotary anchor 412, and a set of rotary teeth 414 fixed to the corresponding rotary anchor. Consistent with embodiments of the disclosure, rotary anchor 412 may be an elongated beam with one end fixedly mounted onto the outer edge of ring-shaped mounting structure 402 and the other end being held by a spring structure 416. As shown in FIG. 4A, rotary anchor 412 extends outwards from ring-shaped mounting structure 402. According to one embodiment, spring structure 416 may be a Chevon spring beam that includes a number of (e.g., one, two, three, four, etc.) pairs of plates. These plates may be equally spaced and may be vulcanized together with rubber in a pair of “V” chevron shapes that face each other to form a rhombus shape. As illustrated in FIG. 4A, the Chevron spring beam 416 may be installed between rotary anchor 412 on one side and a secondary stationary anchor 418 on the other side of the pair of “V” chevron shapes. Once installed, the Chevron spring beam 416 may function as a damper for suspension and may provide compliance in the radial direction, while restraining any other degree-of-freedom (e.g., restricting movements in other directions), thereby facilitating the rotary movements of rotary anchor 412.

Consistent with embodiments of the disclosure, each tooth in a set of stationary teeth 410 or a set of rotary teeth 414 may have a predefined width or a width range, have an arc shape, and have a different length from neighboring teeth to comply with the arc structure of each set of stationary or rotary teeth. Further, stationary teeth 410 and rotary teeth 414 may be also tightly spaced and interleaved with each other when a rotary comb radially moves towards the corresponding stationary comb. Accordingly, a gap between adjacent comb teeth may be spaced in a way to ensure that there is no contact between the teeth during the movement of a rotary comb.

It is to be noted that, while FIG. 4A illustrates four angular comb drive actuators 404 in a support platform, the disclosure is not limited to such a number of angular comb drive actuators 404. In some embodiments, it might be beneficial to increase the number of angular comb drive actuators 404 in a support platform to improve the stability of the radial movements of each angular comb drive actuator 404 due to the less travel distance available for each angular comb drive actuator. However, increasing the number of angular comb drive actuators 404 in a support platform may result in a likely decrease in the maximum rotation angle of the attached Risley prism and thus also a decrease in the field-of-view of a LiDAR system. It may also reduce the number of possible scan patterns that an Alvarez lens-based scanning mechanism could realize. Therefore, the exact number of angular comb drive actuators 404 included in a Risley prism-based scanning mechanism may be a design parameter determined based on the requirements of the applications, among others.

FIG. 4B further illustrates integration of a Risley prism 102 into an angular comb drive actuator-based platform described in FIG. 4A. In some embodiments, for Risley prisms to work properly as a scanning mechanism, all Risley prisms may be controlled to rotate. Accordingly, all Risley prisms may be integrated into a respective platform. For instance, each of Risley prisms 102a and 102b illustrated in FIG. 1A may be separately integrated into such a platform. In this way, both Risley prisms 102a and 102b may rotate independently. For instance, Risley prism 102b may rotate clockwise at a first speed, while Risley prism 102a may rotate anti-clockwise at a second speed. By controlling Risley prisms 102a and 102b to rotate at different speeds and/or different directions, Risley prisms 102a and 102b may be applied to tune scanning patterns generated by a LiDAR system, as previously described.

Referring now to FIG. 5A, a top view of an exemplary Alvarez lens integrated into another comb drive actuator-based platform is also provided, according to embodiments of the disclosure. As illustrated, an Alvarez lens 152 may be integrated into a support platform comprising two comb drives 502a and 502b indicated by the respective dotted boxes. The two comb drives may be disposed on two sides of Alvarez lens 152. Each comb drive 502a or 502b may include a stationary comb and a movable comb. A stationary comb may include a stationary anchor 506a or 506b and a set of stationary teeth 508a or 508b fixed to the corresponding stationary anchor. A stationary comb may be located on a side farther away from Alvarez lens 152 when compared to a movable comb. A movable comb may include a movable anchor 510a or 510b, and a set of movable teeth 512a or 512b fixed to the corresponding movable anchor. In the middle section of a movable anchor, an elongated arm 514a or 514b may extend from a side surface of movable anchor 510a or 510b away from movable teeth 512a or 512b. The two elongated arms 514a and 514b together may hold Alvarez lens 152 from two opposite sides. As illustrated, if Alvarez lens 152 is a cylinder shape, a holding structure 530 may hold Alvarez lens inside the holding structure, and two elongated arms 514a and 514b together may be fixed to holding structure 530 instead. In some embodiments, the two elongated arms 514a and 514b together may hold Alvarez lens 152 from two opposite sides directly. In some embodiments, when a force is applied to comb drive 502a and/or 502b, movable comb(s) may be driven to move, which further causes elongated arms 514a and/or 514b to move, thereby driving the held Alvarez lens 152 to move laterally.

Consistent with some embodiments, each tooth in a set of stationary teeth 508a or 508b or movable teeth 512a or 512b may have a predefined width or a width range. Further, stationary teeth 508a/508b and movable teeth 512a/512b may be also tightly spaced and interleaved with each other when a movable comb moves close to the corresponding stationary comb. Accordingly, adjacent comb teeth may be spaced in a way to form a gap that ensures no contact between the teeth during the movement of a movable comb.

In some embodiments, the length of each tooth, the overlap between the stationary teeth and the movable teeth in the absence of force, and the number of teeth on each stationary comb or movable comb may be selected in consideration of the target force developed between the stationary combs and the movable combs, as well as the maximum displacement length of the attached Alvarez lens 152. According to one embodiment, the length of each tooth in the set of stationary teeth 508a/508b or movable teeth 512a/512b may be at least longer than the maximum travel distance of Alvarez lens 152 when tuning the beam divergence of outgoing laser beams in a sensing process.

In some embodiments, between movable anchor 510a/510b and Alvarez lens 152, a couple of folded flexure suspension structures 516a or 516b may be further disposed symmetrically on two sides of elongated arm 514a or 514b. The folded flexure suspension structures 516a and 516b may allow Alvarez lens 152 and the movable combs to move along one direction (e.g., a direction perpendicular to the optical axis of a transmitter), while restraining any other degree-of-freedom (e.g., restricting movements in other directions). Therefore, Alvarez lens displacement can be properly controlled through comb drive actuators. As illustrated in FIG. 5A, each folded flexure suspension structure 516a or 516b may further include a suspension anchor 518a or 518b and a couple of column beams 520a or 520b. Suspension anchor 518a or 518b may be fixed and non-movable. Meanwhile, column beam 520a or 520b may itself include a spring structure that deflects to accommodate the movements of elongated arm 514a/514b and the corresponding movable comb moving towards the respective stationary comb. The spring structure may act as a spring to restore a moved comb and Alvarez lens 152 to their default positions (e.g., positions when there is no displacement for Alvarez lens 152) in the absence of an applied force. It is to be noted that the above configuration of folded flexure suspension structures 516a or 516b is merely one example configuration, and the disclosure contemplates other forms of folded flexure suspension structures or even other forms of controlling mechanisms for controlling the lateral movement of Alvarez lens 152 while restricting other degree-of-freedom.

FIG. 5A merely illustrates integration of one Alvarez lens into a comb drive actuator-based platform. However, for the pair of Alvarez lenses to work properly, both Alverez lens elements (e.g., Alverez lenses 152a and 152b in FIG. 1B) may be controlled to move, according to some embodiments. Therefore, each of Alvarez lens 152a or 152b may be integrated into a platform as shown in FIG. 5A, as illustrated in FIG. 5B. In this way, both Alvarez lens elements may move independently. For instance, Alvarez lens 152b may move to the left, while Alvarez lens 152a may move to the right, as indicated by the dotted arrows in FIG. 5B. By controlling one or both Alvarez lenses 152a and 152b to move laterally, the Alvarez lens pair may be then applied to tune the beam divergence of an outgoing laser beam by a LiDAR system, as previously described.

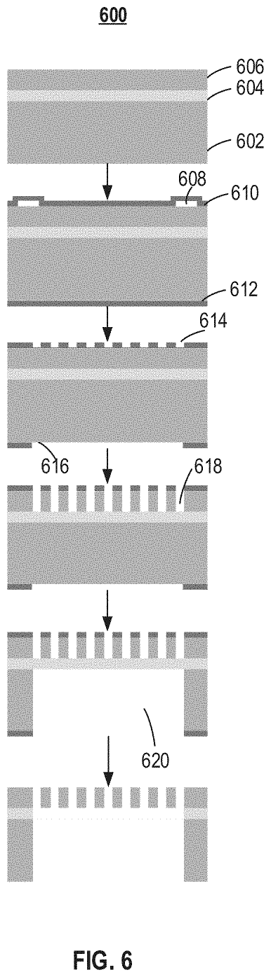

The disclosure also provides an exemplary process 600 for fabricating the major structures of the foregoing comb drive actuator-based platforms described in FIGS. 4A-5B. It is to be noted that, process 600 in FIG. 6 is merely for illustrative purposes, but does not necessarily reflect every detail in the actual fabrication of the disclosed comb drive actuators. For instance, certain comb drive shapes and structures illustrated in FIGS. 4A-5B are not necessarily detailed in FIG. 6.

Microfabrication of an angular comb drive actuator-based platform main structure for a Risley prism will be described first. In this embodiment, a microfabricated angular comb drive actuator-based platform main structure may correspond to an angular comb drive actuator-based platform illustrated in FIGS. 4A-4B. In some embodiments, a silicon on insulator (SOI) wafer having three different layers may be prepared for microfabrication of an angular comb drive actuator-based platform. The three layers may include a bottom silicon substrate layer 602 (which may be also referred to as handle layer), a buried oxide (BOX) layer 604 in the middle, and a top active primer quality silicon device layer 606 (which may be also referred to as device layer). Depending on the configurations, the three layers 602, 604, and 606 may have different thicknesses. In one example, device layer 606 may have a thickness corresponding to the thickness of comb drive structures (e.g., ring-shaped mounting structure 402, rotary anchor 412, rotary teeth 414, stationary teeth 408, etc.). According to non-limiting examples, device layer 606 may have a thickness of 10 μm, 20 μm, 30, μm, 40 μm, 50 μm, etc. BOX layer 604 may have a much smaller thickness, which may be 1 μm, 2 μm, 3 μm, 4 μm, 5 μm, etc. Silicon substrate layer 602 may have a thickness close to or larger than device layer 606. For instance, silicon substrate layer 602 may have a thickness of 50 μm, 100 μm, 150 μm, etc.

In some embodiments, to form bonding pads for wire bonding (e.g., for bonding with cathode and anode configured for controlling movements of rotary anchor 412) of the formed angular comb drive actuator-based platform, a metal film 608 may be sputtered and patterned in bonding-pad shapes over certain locations of silicon device layer 606.

Next, a thin (e.g., 0.25 μm, 0.5 μm, 0.75 μm, 1.0 μm, etc.) thermal oxide (i.e., SiO₂) layer 610 may be grown over the top silicon device layer 606 as well as the bonding-pad shaped metal film 608, to serve as a masking layer in defining the main structure of an angular comb drive actuator-based platform, as will be described later. Similarly, another thermal oxide layer 612 may be also grown under silicon substrate layer 602 to serve as a masking layer, to make the backside process easier in later backside cavity etching. In some embodiments, other photo resist (PR) materials, instead of oxide, may be used here for respective layers 610 and 612 for forming patterned hard masks as described below.

Next, a photolithography pattern transfer process may be performed, and a hard mask layer 614 (which may be referred to as the first patterned hard mask) may be then prepared on silicon device layer 606, e.g., through reactive ion etching (RIE). The first patterned hard mask may correspond to a main structure illustrated in FIG. 4A for an angular comb drive actuator-based platform, except for certain components (e.g., spring structures 416, stationary anchors 408, and secondary stationary anchors 418) that may not be necessarily fabricated through process 600. In some embodiments, a second patterned hard mask 616 may be similarly performed on the backside (i.e., the bottom surface) under the silicon substrate layer 602. The second pattern on the backside may be a cavity in the center, to provide an optical window for laser beams to pass through a to-be-integrated optical component (e.g., a Risley prism 102). In some embodiments, each of the first patterned hard mask 614 or second patterned hard mask 616 may be a PR mask, which may be made from a light-sensitive material used in processes such as photolithography and photoengraving, to form a patterned coating on a surface.

Next, angular comb drive-based platform main structure 618 (i.e., an angular comb drive actuator-based platform except for the spring structures 416, stationary anchors 408, and secondary stationary anchors 418) may be formed from the front side (i.e., top side in FIG. 6) of silicon device layer 606 of the SOI wafer through an etching process. In one example, a deep-reactive ion etching (DRIE) technology may be used for etching, although other etching processes are also possible. During the deep-reactive ion etching, C₄F₈, SF₆, and O₂ may be provided in an inductively coupled plasma (ICP) system, in which C₄F₈ may be first used as the passivation precursor to protect the side wall, then SF₆/O₂ may serve as the etching gases for silicon etching downward. In some embodiments, the backside cavity of the silicon substrate layer 602 with the second patterned hard mask 616 may be similarly etched through the DRIE etching, to form the backside cavity 620.

Next, buried oxide layer 604 may be etched away in order to release the fabricated comb drive actuator-based platform main structure 618. In some embodiments, hydrofluoric acid (HF) vapor may be used to etch away buried oxide layer 604, which other etching processes may be also possible. It is to be noted, although not shown in the exact detail, the released comb drive actuator-based platform main structure 618 may include the main components of an angular comb drive actuator-based platform illustrated in FIG. 4A, except for spring structure 416, stationary anchor 408, and secondary stationary anchor 418 in each of the plurality of angular comb drive actuators 404.

In some embodiments, a microfabricated Risley prism 102 may be integrated into the released comb drive actuator-based platform main structure 618. For instance, a microfabricated Risley prism 102 may be integrated onto the comb drive actuator-based platform main structure 618 via a micro-assembly process under the assistance of a microscope for alignment and an epoxy adhesive for fixing. In some embodiments, spring structure 416 and stationary anchor 408, and secondary stationary anchor 418 for each of the plurality of angular comb drive actuators 404 may also be disposed to the corresponding positions/structures to form a complete angular comb drive actuator-based platform shown in FIG. 4A. In some embodiments, a plurality of such platforms with integrated Risley prisms may be further aligned along an optical path of a transmitter of a LiDAR system and used as a scanning mechanism of the LiDAR system.

In some embodiments, a comb drive actuator-based platform main structure (i.e., without stationary anchors 506a and 506b and folded flexure suspension structures 516a and 516b) shown in FIG. 5A may be similarly fabricated through process 600, except that the first and second patterned hard masks 614 and/or 616 may be different from described above for fabricating the structure in FIG. 4A. A microfabricated Alvarez lens 152 may be then integrated into such a main structure. Additionally, stationary anchors 506a and 506b and folded flexure suspension structures 516a and 516b may be further disposed to the corresponding positions/structures to form a complete comb drive actuator-based platform shown in FIG. 5A. In some embodiments, a plurality of such platforms with integrated Alvarez lenses 152 may be further aligned along an optical axis of a transmitter of a LiDAR system and used as a tunable collimation lens to tune beam divergence of outgoing laser beams, as previously described.

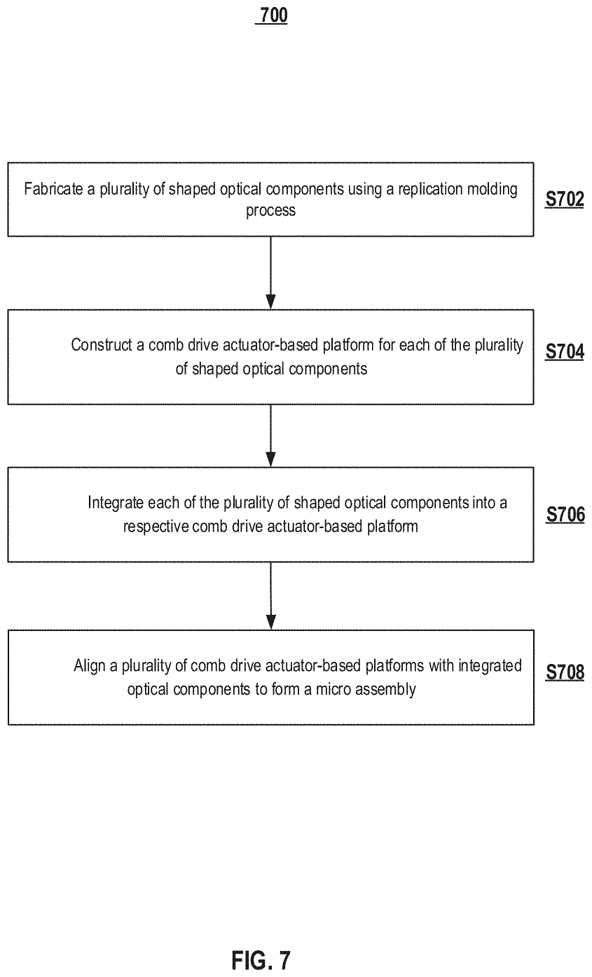

It is to be noted that the comb drive actuator-based platforms of FIG. 4A-5B for holding optical components fabricated through process 200 or 300 are merely exemplary platforms that can be fabricated with process 600. In some embodiments, other comb drive actuator-based platforms for integration of different optical components fabricated through process 200 or 300 can also be fabricated by process 600 with certain modifications within the capability of a person of ordinary skill. In some embodiments, a plurality of comb drive actuator-based platforms with integrated optical components for a LiDAR system may be also further aligned together to form a micro assembly, as described in detail in FIG. 7.

FIG. 7 is a flow chart of an exemplary method 700 for making a micro assembly with a plurality of movable optical components, according to embodiments of the disclosure. In some embodiments, method 700 may include steps S702-S708. It is to be appreciated that some of the steps may be optional. Further, some of the steps may be performed simultaneously, or in a different order than that shown in FIG. 7.

In step 702, one or more shaped optical components may be fabricated using a replication molding process. For instance, two or more Risley prisms 102 may be fabricated through a replication molding process illustrated in FIG. 2. For another instance, a pair of Alvarez lenses 152 may be fabricated through a replication molding process illustrated in FIG. 3. In some embodiments, each Risley prism 102 may be identical or different in structure and optical properties. Similarly, each Alvarez lens 152 may be identical or different in structure and optical properties, too.

In step 704, a comb drive actuator-based platform may be constructed for each of the plurality of the shaped optical components. In some embodiments, a microfabrication process illustrated in FIG. 6 may be applied to fabricate the main structure of such a platform. In some embodiments, additional components such as stationary anchors and spring structures may be further disposed into the main structure of each platform fabricated through process 600, to further form a complete comb drive actuator-based platform as shown in FIG. 4A or FIG. 5A. As can be also seen from FIG. 4A or FIG. 5A, comb drive actuator-based platforms with different shapes and structures may be constructed through the described process in FIG. 6.

In step 706, each of the plurality of fabricated optical components may be integrated into a respective comb drive actuator-based platform. For instance, a Risley prism 102 may be integrated into an angular comb drive actuator-based platform, as shown in FIG. 4B. Similarly, an Alvarez lens 152 may be integrated into a comb drive actuator-based platform, as shown in FIG. 5B.

In step 708, a plurality of comb drive actuator-based platforms with integrated optical components may be aligned to form a micro assembly. For instance, two or more angular comb drive actuator-based platforms with integrated Risley prisms may be aligned along an optical path of a transmitter of a LiDAR system, to form a micro assembly. Such micro assembly may be used as a scanning mechanism of the transmitter of the LiDAR system, and can be used to scan the environments at different scanning patterns. For another instance, two comb drive actuator-based platforms with integrated Alvarez lenses may be aligned along an optical axis of a transmitter of a LiDAR system, to form another micro assembly. Such micro assembly may be used as a tunable collimation lens that can be used to tune beam divergence of outgoing laser beams.

It is to be noted that while two different micro assemblies are described in the foregoing embodiments, the disclosure is not limited to such micro assemblies. The disclosed methods may be applied to fabricate other micro assemblies that can be used to tune or dynamically adjusted certain optical properties of a LIDAR system in environmental sensing.

Although the disclosure is made using a LiDAR system as an example, the disclosed embodiments may be adapted and implemented to other types of optical sensing systems that use receivers to receive optical signals not limited to laser beams. For example, the embodiments may be readily adapted for optical imaging systems or radar detection systems that use electromagnetic waves to scan objects.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A method for fabricating a shaped optical component using a replication molding process, the method comprising:
creating a master mold containing a substrate with a predefined surface contour;
generating a polydimethylsiloxane (PDMS) mold with a concave part having an inverse pattern matching the predefined surface contour;
filling the concave part of the PDMS mold with a light-curable optical adhesive;
sealing the optical adhesive-filled concave part with a flat PDMS slab to form a PDMS structure;
curing and hardening the optical adhesive inside the PDMS structure to form the shaped optical component; and
detaching the shaped optical component from the PDMS structure.

2. The method of claim 1, wherein the shaped optical component is a Risley prism.

3. The method of claim 1, wherein the shaped optical component is an Alvarez lens.

4. The method of claim 1, wherein the substrate in the master mold is an aluminum substrate.

5. The method of claim 1, wherein the predefined surface contour is created by using a single-point diamond turning technique with a freeform surface fabrication capability.

6. The method of claim 1, wherein the predefined surface contour is created by using a computer numerical control (CNC) milling process.

7. The method of claim 1, wherein generating the PDMS mold comprises:
pouring liquid PDMS onto the master mold with the predefined surface contour;
cooling the liquid PDMS under a predefined temperature to allow the liquid PDMS to harden; and
detaching the hardened PDMS as the PDMS mold.

8. The method of claim 7, wherein the liquid PDMS is prepared by mixing a base and a curing agent at a predefined ratio.

9. The method of claim 8, wherein the base comprises a silicone.

10. The method of claim 1, wherein the light-curable optical adhesive is a UV-curable optical adhesive.

11. The method of claim 10, wherein curing and hardening the optical adhesive comprises:
curing the optical adhesive by exposing the PDMS structure under a UV light for a predefined period; and
hardening the cured optical adhesive at a certain temperature range.

12. The method of claim 11, wherein hardening the cured optical adhesive at a certain temperature range comprises placing the PDMS structure in a convection oven with a temperature set within the certain temperature range.

13. A method for making a micro assembly with a plurality of movable optical components, the method comprising:
fabricating a plurality of shaped optical components using a replication molding process;
constructing a comb drive actuator-based platform for each of the plurality of shaped optical components;
integrating each of the plurality of shaped optical components into a respective comb drive actuator-based platform; and
aligning a plurality of comb drive actuator-based platforms with integrated shaped optical components to form the micro assembly.

14. The method of claim 13, wherein constructing a comb drive actuator-based platform for each of the plurality of shaped optical components comprises:
preparing a silicon on insulator (SOI) wafer containing a silicon device layer, a buried oxide (BOX) layer, and a silicon substrate layer;
applying a first patterned hard mask over the silicon device layer and a second patterned hard mask under the silicon substrate layer;
etching the silicon device layer with the first patterned hard mask for forming a front side comb drive actuator-based platform main structure;
etching the silicon substrate layer with the second patterned hard mask to create a backside cavity; and
etching away the buried oxide layer to release the comb drive actuator-based platform main structure.

15. The method of claim 14, further comprising:
disposing certain spring structures and stationary anchors to form a complete comb drive actuator-based platform.

16. The method of claim 14, wherein each of the first patterned hard mask and the second patterned hard mask comprises a photo resist (PR) mask.

17. The method of claim 14, wherein the silicon device layer and the silicon substrate layer are etched using a deep-reactive ion etching (DRIE) process.

18. The method of claim 14, wherein the first patterned hard mask is patterned to be a shape corresponding to a shape of a comb drive actuator-based platform.

19. The method of claim 13, wherein each of the plurality of shaped optical components is integrated into the respective comb drive actuator-based platform via a micro-assembly process under an assistance of a microscope.

20. The method of claim 13, wherein each of the plurality of shaped optical components is further fixed to a respective comb drive actuator-based platform using an epoxy adhesive.
